(19) United States
(12) Patent Application Publication
(10) Pub. No.: US 2010/0183848 A1
(43) Pub. Date: Jul. 22, 2010

(54) Metal-Plastic-Hybrid Casing Component

(75) Inventor: Frank Krause, Bergisch Gladbach (DE)

Correspondence Address: Hildebrand, Christa;Norris McLaughlin & Marcus PA, 875 Third Avenue, 8th Floor, New York, NY, 10022, US

(73) Assignee: LANXESS Deutschland GmbH, Leverkusen (DE)

(21) Appl. No.: 12/640,635

(22) Filed: Dec. 17, 2009

(30) Foreign Application Priority Data
Dec. 18, 2008 (DE) 10 2008 063 745.9

(51) Int. Cl. B32B 3/30; B32B 3/00; B32B 37/24

(52) U.S. Cl. 428/167; 428/209; 156/242

(57) ABSTRACT

A casing component, which comprises at least one force-input structure in the form of a metal sheet, by way of which the plastics casing component is fastened on an adjacent casing structure, where, after the molding-on of the plastic, the plastic of the casing component bilaterally covers, or has been laminated onto, at least ⅔ of the force-input structure, and the force-input structure comprises at least one fastening device, in order to fasten the casing component on the casing structure by way of the force-input structure.

### BACKGROUND OF THE INVENTION

(1) Field of the Invention

The present invention relates to a casing component with force-input structure, using a metal sheet for input of local forces into the casing component.

(2) Description of Related Art

DE 198 18 590 C2 discloses an oil pan with sealing area for leakproof attachment to an adjacent engine-casing structure, where this comprises a gasket flange composed of metal material and comprising the sealing areas, and comprises, attached thereto, a wall region composed of plastics material. In particular, said oil pan comprises a grid frame produced in the form of an injection molding from lightweight metal, the wall region of the oil pan composed of plastics material being molded onto this frame, the result being intimate bonding to the grid. The grid forms an “outer skeleton” from the relatively soft wall area composed of plastic. In comparison with conventional oil pans produced entirely from metal materials, for example from deepdrawn metal sheet, the advantage of this type of hybrid design is a substantial weight reduction. However, a disadvantage is that it is complicated to produce: the grid frame composed of metal first has to be produced before molding-on of the wall region of the oil pan, composed of plastic, can be carried out in a further production step. On the other hand, by way of example DE-A 103 32 171 discloses a casing part composed entirely of plastics material, an example being an oil pan. Straight-plastics components of this type combine lightweight design with a simple production process, but have the disadvantage that in practice it is difficult to achieve leakproof attachment to the adjacent casing structure. In particular, there are seating problems. In practice, it has therefore been found that the only way of obtaining a durably leak-proof attachment is in practice to use an additional sealing element, such as a sealing ring.

DE 10 2006 025 745 A1 discloses a metal-plastic-hybrid casing component with sealing area for leakproof attachment to an adjacent casing structure; this is a lightweight component which has adequate stability, can be produced simply and at low cost, and, together with this, can be attached, like a conventional sheetmetal oil pan, in a durably leakproof manner to the adjacent casing structures.

EP 1 511 924 A1 also discloses an oil pan, which comprises a casing composed of plastics material, and, integrated into the plastics material, a supportive structure composed of, for example, metal.

As is the case with straight-plastics components, the metal-plastic-hybrid components have the disadvantage that it is difficult in practice to achieve leakproof attachment to the adjacent casing structure, for example of an engine casing or transmission casing. Nor does the use of additional sealing elements always lead to a durably leakproof seal between metal-plastic-hybrid component and adjacent casing structure.

DE 103 17 484 A1 attempts to solve this problem by proposing a fastening element with a plurality of bushings connected to one another via connection webs and intended for screw-thread connections, and with a flange. However, the increased number of screw-thread connections leads to higher weight, because of the large number of bolts that have to be used, and moreover requires more time for assembly and dismantling.

A fastener as proposed in DE 601 29 978 T2 for engine add-on parts would provide an alternative method of fastening.

It is also possible to use self-tapping screws to introduce local forces. These screws are screwed into screw domes, which are molded-on in the injection-molding process. The maximum forces that can be input therewith into the plastics component depend on the strength of the thermoplastic and on the structural design of the screw dome, and are therefore subject to certain restrictions.

The use of metal inserts and of screw domes can provide only a restricted increase in the forces intended for local introduction, since there is only an insignificant enlargement of the area used to input the forces into the plastics component.

In the case of plastics components which are intended for use as load-bearing structural components, the forces introduced are very large, and local introduction of these produces stresses that are too high for the plastics component and leads to failure.

All of the alternatives have the disadvantage of either increasing the number of screw-thread connections and therefore increasing the weight, and increasing the cost of assembly or dismantling, or, as in the case of the fastener, failing to provide ideal input of local forces into the component to be fastened.

### BRIEF SUMMARY OF THE INVENTION

It was therefore an object to improve force-input into components composed of plastics in such a way that local forces are input uniformly via a metal sheet into the component to be fastened, without any significant increase in processing costs, or fastening costs, or the weight of the component to be fastened.

The object is achieved, and the present invention therefore provides, a casing component, which comprises at least one force-input structure in the form of a metal sheet, by way of which the plastics casing component is fastened on an adjacent casing structure, where, after the molding-on of the plastic, the plastic of the casing component bilaterally covers, or has been laminated onto, at least ⅔ of the force-input structure, and the force-input structure comprises at least one fastening device, in order to fasten the casing component on the casing structure by way of the force-input structure.

Surprisingly, the high local stresses are absorbed in the region of the metal, without any damage within the metal. The metal sheet then distributes the incident force in such a way that none of the stresses rising within the laminated plastics component leads to any failure within the plastic. Use is made here of the fact that metals have a significantly higher failure threshold than plastics. Breaking stresses are from 3 to 10 times higher than for thermoplastics. Metal structures can therefore withstand significantly higher local forces.

For clarification, it should be noted that the scope of the invention encompasses any desired combination of any of the definitions and parameters that are mentioned either in general terms or in preferred ranges below.

In one preferred embodiment, the thermoplastic of the casing component covers, or has been laminated to, from ⅔ to ¾ of the force-input structure.

In one preferred embodiment, the design of the wall thickness of the metal sheet is such that the local forces to be introduced do not exceed the maximum permissible stress level of the metal of the force-input structure. The wall thickness of the metal sheet here is at least ⅙ and at most ⅔ of the wall thickness of the plastics casing component.

In another preferred embodiment, the breadth and length of the metal sheet are at least 10 times the wall thickness.

In another preferred embodiment, in order to inhibit a rectangular buckling of the plastics component when forces are too high, the plastics component can be provided with ribs standing perpendicularly on the surface of the plastics component. These perpendicular ribs have at least ⅓ and at most 4/3 of the wall thickness of the plastics component.

The metal used preferably comprises steel in a very wide variety of alloys, or comprises lightweight metals, particularly preferably aluminum or magnesium, or else comprises nonferrous metals, particularly preferably copper, brass, or zinc.

One preferred method of bonding the metal sheet of the force-input structure to the plastic is incipient etching of the metal surface prior to molding-on of the plastic, so that an adhesive bond is produced after the overmolding of the metal surface. This process is described by way of example in EP 1 958 763 A1.

Another preferred method, for laminating the metal sheet to the thermoplastic component, is molding-on by way of an interlock bond. In this process, a perforation structure is introduced into the metal sheet of the force-input structure, and the thermoplastic flows through this perforation structure during the injection-molding process, thus mechanically securing the metal sheet. Said perforation structure can be composed of many individual serial or offset connection points or connection webs. The perforations of the perforation structure are preferably circular or oval. The area of all of the perforations is preferably at least ⅙ and at most ⅔ of the area of lamination of the metal sheet to the plastics component.

In another preferred embodiment, the metal sheet of the force-input structure can also be provided with local impressions (depressions), in order to produce an interlock bond during the injection-molding process. The extent of the depression is at least ½ and at most three times the wall thickness of the metal sheet.

In one particularly preferred embodiment, it is also possible to select, for the interlock bond, a combination of a perforation structure and local depressions in the metal sheet of the force-input structure.

In another preferred embodiment, it is also possible to achieve bonding through controlled roughening of the surface of the metal sheet of the force-input structure. This is particularly useful in combination with an incipient etching process.

In another embodiment, the metal sheet has been attached over the entire distance between two or more fastening devices.

In another preferred embodiment, if incident forces are not to be directly input into the metal sheet, the metal sheet of the force-input structure can have been angled in order to permit force input. It is preferable to use an angle of 90°. However, angular sheetmetal necessitates a greater wall thickness for the metal sheet, since very high bending stresses arise in the region of the angle. Because of the high bending stresses, the wall thickness of an angular metal sheet is at least ⅓ of and at most equal to the wall thickness of the plastics casing component.

For the purposes of the present invention, preference is given to use of the following plastics for the casing component: polyester, polyolefins, polyphenylene sulfides, polyphenylene ethers, polyamides, polyurethanes, polycarbonates, or polyalkylenes, and particularly preferably semicrystalline thermoplastics. In particular, polyamides are especially preferred.

The polymers to be used as plastic are preferably semicrystalline thermoplastics, provided in the form of molding compositions and injected through shaping processes. For the purposes of the present invention, shaping processes are preferably injection molding, melt extrusion, compression, or blow molding.

In one preferred embodiment, the casing component is itself a metal-plastic-hybrid casing component as widely previously described in the prior art. In one particularly preferred embodiment, the casing component is a metal-plastic-hybrid oil pan or an intermediate frame for the type of oil pan for example used in drive assemblies, preferably of cars or trucks, and described in DE 10 2006 025 745 A1. However, it can also be any other engine-casing component or any other transmission-casing component, or any other casing component which is attached by a sealing area to an adjacent structure, for example an adjacent casing structure.

However, in the invention, in contrast to the prior-art embodiment, both the hybrid casing component composed of metal and the force-input structure(s) are provided in the injection mold prior to the extrusion of the plastic, and plastic is extruded onto both together, in one operation. In an alternative embodiment, the force-input structure(s) can have been connected to the metal portion of the casing component via suitable means, so that both the casing component and the force-input structure(s) are placed in the injection mold in a single movement.

It is therefore preferable that the present invention provides a casing component with sealing area for leakproof attachment to an adjacent casing structure, where this comprises a gasket flange composed of metal material and comprising the sealing area, and comprises, attached thereto, a wall region composed of plastics material, where an attachment strip has been provided integrally at the gasket flange, where the wall region has been attached bilaterally by cohesive bonding to the attachment strip, and the casing component comprises at least one force-input structure in the form of a metal sheet, by way of which the casing component composed of thermoplastic is fastened on the adjacent casing structure, the plastic of the casing component bilaterally covers, or has been laminated to, at least ⅔ of the force-input structure, and the force-input structure comprises at least one fastening device for fastening of the casing component to the casing structure by way of the force-input structure.

One preferred embodiment of the present invention therefore provides a hybrid casing component which uses a conventional metal gasket flange, to which the wall region composed of plastics material has been attached by way of an attachment strip and bilateral cohesive bonding. The use of the gasket flange composed of metal material permits attachment of the hybrid casing component, like a conventional sheetmetal oil pan, to the adjacent casing structure by conventional sealing processes, i.e. with use of a sealing composition, by way of example composed of silicone material and applied to the sealing area prior to the attachment process. The sealing flange with the attachment strip can be produced at very low cost from simple sheetmetal material via stamping and deepdrawing, and can provide considerable strength to the casing component and in particular to the sealing area. Secure bonding of the wall region composed of plastic has been provided via bilateral attachment at the attachment strip, and also via the incorporated force-input structure(s).

There can be a bonding agent provided bilaterally over the area of the attachment strip, producing the cohesive bond between the plastics material of the wall area and the metal material of the gasket flange. The bonding agent can have been provided over the entire area or only in regions.

The bonding agent can also have been provided on the gasket flange, where it can have been provided bilaterally or monolaterally, and also over the entire area or only in regions. The bonding agent can be corrosion-resistant, and can protect the metal material of the gasket flange and of the attachment strip from corrosion.

Particularly if the bonding agent is applied to the sheetmetal material prior to the stamping and deepdrawing process, it can be advantageous to provide plastics material bilaterally at marginal regions in the vicinity of cut edges of the sheetmetal material, so that the cut edges have been covered by the plastics material in such a way as to provide watertight sealing of the cut edge by the plastics material. This applies in particular to cut edges which in use are exposed to a corrosive environment, for example in the region subject to water spray in the case of an oil pan of a motor vehicle. It is therefore particularly advantageous that the cut edge located in the region of the external periphery of the gasket flange is covered with plastic. It can also be advantageous for the gasket flange in the region of the screw-thread apertures to be bilaterally covered with plastic and for the corresponding cut edges of the screw-thread apertures to thus be sealed. It can also be advantageous for the entire gasket flange or in essence the entire gasket flange to be covered with a thin plastics layer. In terms of production technology, this can be relatively easily achieved during the molding-on of the wall region composed of the plastics material.

Those marginal regions of the gasket flange which do not form the attachment strip, i.e. typically the peripheral external marginal regions of the gasket flange, can have been deflected away from the sealing area. Deflection of the marginal regions firstly increases stability. Secondly, it is particularly easy to overmold the upward-deflected marginal regions bilaterally with plastics material, so as to seal off the cut edge there securely from corrosive environmental effects.

The sealing area defines a sealing-area plane, and the attachment strip can have been provided with an angle relative to the sealing-area plane. The attachment strip can preferably have been deflected relative to the sealing-area plane, and so juts away from the sealing area in the opposite direction to the sealing area. The attachment strip can particularly preferably, when viewed in cross section, have a plurality of bends.

The purpose of the multiple bending of the attachment strip is that loading of the coherent bond between the plastics material and the metal material produces shear not only in the direction of the interface but also with a component at right angles to the interface. Another result of this is an interlock bond in addition to the cohesive bond between the plastics material and the metal material. The multiple bonding can also increase stability in the direction of the periphery, and elasticity in the direction toward the sealing area. In particular, the attachment strip can have been bent in a shape which is substantially that of an S.

Within the wall region, there can be an attachment provided, for example an inset attachment region to receive an oil-temperature sensor, etc. There can be a contact lug provided integrally with the gasket flange or, respectively, the attachment strip. Some components, such as fill-level sensors, etc., need an electrical contact. The contact lug can form this type of contact. The contact lug can be produced relatively easily during the stamping and deepdrawing process, and the plastics material of the wall can overmold this lug practically completely, or to some extent, or not at all. The location of the lug is typically within the interior, for example within the interior of the oil pan, and there is therefore no requirement here for corrosion protection for the cut edges. The contact lug can simultaneously provide, for the corresponding component, an inset for insertion of a screw thread, and therefore can have been at least to some extent included in the injection of the plastics material of the wall. By way of example, contact with the adjacent casing structure can have been produced in that the contact lug has been bent in such a way that, in use, prestressing causes it to press against a contact area of the adjacent casing structure.

The gasket flange preferably comprises screw-thread holes, and, in one particularly preferred embodiment, there can be a screw-thread insertion socket or a screw-thread insertion dome, or a force-input structure, molded onto each screw-thread hole. This permits screw-connection of a component against the gasket flange, where the screw thread can be screwed into the screw-insertion dome of the casing component, where it has then been fixed, the incident forces being dissipated into the component by way of the force-input structure(s). If necessary for reasons of strength, the force-input structure can be provided as a portion of the screw-thread insertion socket in one preferred embodiment.

In order, in the course of screwed attachment to the engine casing, to distribute the arising forces more uniformly over the casing component, the force-input structures preferably attach to the attachment strip or sealing flange or are integrated therein on one side.

If one side of the force-input structure attaches to the attachment strip/sealing flange, it spans a part of the casing component and is at least ⅔ embedded in the plastic wall region of said component.

That portion of the force-input structure not surrounded by the plastic comprises fastening devices, preferably drilled holes or screw-thread domes, through which screw threads are passed, in order to fasten the casing component on a casing structure. In the case of an oil pan, the casing structure is the engine block or transmission block.

The invention further relates to a drive assembly of a means of locomotion comprising a casing component of the invention. The drive assembly can be a drive motor or a transmission system of a means of locomotion, preferably of a car or of a truck.

The casing component can have been attached by an engine gasket flange to the drive motor or by a transmission gasket flange to the transmission system. The engine gasket flange and the transmission gasket flange can respectively comprise an attachment strip for attachment of the wall region, and the engine gasket flange and the transmission gasket flange can have been provided in the form of an integral stamped sheet metal part to the region sealed from the drive motor and to the region sealed from the transmission or transmission block. The dividing wall may provide a fluid-tight closure. Alternatively it may be provided as a further structural reinforcement or stiffening.

The drive assembly may have an intermediate frame and an oil pan, in which case it is possible for one or both of these components to be formed in accordance with the invention. The gasket flange for the connection of the oil pan to the intermediate frame may be formed substantially in the same way as the engine or transmission gasket flange.

The oil pan and/or the intermediate frame may have a fill-level sensor which is connected to ground by means of the contact lug. The engine and/or transmission gasket flange may be integrally connected by means of the contact lug to the gasket flange for the connection of the oil pan.

The invention further provides a process for the production of a casing component in accordance with the present invention, having the following steps:
a) stamping and deepdrawing of the force-input structure and of the gasket flange and of the attachment strip from a metal sheet material;
b) insertion of the gasket flange with the attachment strip and with the force-input structure(s) into a plastics-injection mold;
c) production of the wall region by injection molding, with
d) bilateral overmolding of the attachment strip.

In particular through the combination of the production of the metal part by stamping and deepdrawing from a metal sheet material with the use of the plastics injection-molding process it is possible to produce the casing component of the invention in a particularly simple and inexpensive procedure.

The metal sheet material may have been provided with adhesion promoter preferably on both sides even prior to stamping and deepdrawing. It is advantageous for the adhesion promoter to possess a certain viscosity, so that it goes along with the necessary forming steps, without detaching from the underlying metal sheet.

The metal sheet material may in one preferred embodiment be provided preferably on both sides with anticorrosive even prior to stamping and deepdrawing. With particular preference the anticorrosive possesses a sufficient viscosity and so goes along with the required forming steps without detaching from the underlying metal sheet.

Furthermore it is also possible to attach the plastic only on one side, internally or externally, to the metal frame interlockingly and/or integrally. As already described above, the invention gives preference to using plastics from the group consisting of polyesters, polyolefins, polyphenylene sulfides, polyphenylene ethers, polyamides, polyurethanes, polycarbonates or polyalkylenes, more preferably semicrystalline thermoplastics. Polyamides are used with more particular preference.

The semicrystalline thermoplastics to be used as the plastic are introduced in the form of molding compositions and are extruded through shaping processes, preferably injection molding, melt extrusion, compression or blow molding, to give the casing component with force-input structure(s).

Molding compositions to be used with preference comprise from 99.99 to 10 parts by weight, preferably from 99.5 to 40 parts by weight, particularly preferably from 99.0 to 55 parts by weight, of one of the abovementioned thermoplastics or mixtures of one or more of the above-mentioned thermoplastics.

Polyamides to be used with particular preference are nylon-6 (PA 6) and also nylon-6,6 (PA 66) with relative solution viscosities (measured in m-cresol at 25° C.) of from 2.0 to 4.0, and in particular preference is especially given to nylon-6 with a relative solution viscosity (measured in m-cresol at 25° C.) of from 2.3 to 2.6, or mixtures composed of
A) from 99.99 to 10 parts by weight, preferably from 99.5 to 40 parts by weight, particularly preferably from 99.0 to 55 parts by weight, of polyamide with at least B) from 0.01 to 50 parts by weight, preferably from 0.25 to 20 parts by weight, particularly preferably from 1.0 to 15 parts by weight, of an additional flow improver from the group of
B1) a copolymer composed of at least one olefin, preferably one α-olefin, with at least one methacrylic ester or acrylic ester of an aliphatic alcohol, preferably of an aliphatic alcohol having from 1 to 30 carbon atoms, whose MFI is not less than 100 g/10 min, where the MFI (melt flow index) is measured or determined at 190° C. and with a test weight of 2.16 kg, or
B2) a highly branched or hyperbranched polycarbonate with an OH number of from 1 to 600 mg KOH/g of polycarbonate (to DIN 53240, part 2), or
B3) a highly branched or hyperbranched polyester of AₓB_{y} type, where x is at least 1.1 and y is at least 2.1, or
B4) a polyalkylene glycol ester (PAGE) with low molecular weight, of the general formula (I)

R—COO—(Z—O)ₙOC—R (I)
in which
R is a branched or straight-chain alkyl group having from 1 to 20 carbon atoms,
Z is a branched or straight-chain C₂-C₁₅-alkylene group, and
n is a whole number from 2 to 20, or
   mixtures of B1) with B2), or of B2) with B3), or of B1) with B3), or of B1) with B2) and with B3), or of B1) with B4), or of B2) with B4), or of B3) with B4), or ternary mixtures of components B1) to B4), in each case with A), where the secure interlock bond between main body and thermoplastic is achieved by way of the galvanized iron surface of the main body.

However, according to the invention, the term polyamide also includes polyamides which comprise linear macromolecular chains and macromolecular chains having a star-shaped structure. These polyamides, which have improved flow by virtue of their structure, are obtained by polymerizing, as in DE 699 09 629 T2, a mixture of monomers which comprises at least

a) monomers of the general formula (II) R₁-(-A-Z)ₘ,
b) monomers of the general formula (Ma) X—R₂—Y and (IIIb) R₂—NH—C═O,
c) monomers of the general formula (IV) Z—R₃—Z, in which

R₁ is a linear or cyclic, aromatic or aliphatic hydrocarbon moiety which comprises at least two carbon atoms and which can comprise heteroatoms,

A is a covalent bond or an aliphatic hydrocarbon moiety having from 1 to 6 carbon atoms,

Z is a primary amine moiety or a carboxy group,

R₂ and R₃ are identical or different and are aliphatic, cycloaliphatic, or aromatic, substituted or unsubstituted hydrocarbon moieties which comprise from 2 to 20 carbon atoms and which can comprise heteroatoms, and

Y is a primary amine moiety, if X is a carbonyl moiety, or Y is a carbonyl moiety, if X is a primary amine moiety, where m is a whole number from 3 to 8.

The molar concentration of the monomers of the formula (II) in the monomer mixture is from 0.1% to 2%, and that of the monomers of the formula (IV) is from 0.1% to 2%, where the balance to 100% corresponds to the monomers of the general formulae (IIIa) and (IIIb).

The molding-on of the thermoplastic is preferably achieved in a single operation. In the event that the main body additionally still has perforations that require overmolding, the procedure for the molding-on and overmolding of the thermoplastic can be carried out in two, three or more steps.

Polyamides particularly preferred in the invention are described by way of example in Kunststoff-Taschenbuch [Plastics Handbook] (Ed. Saechtling), 1989 edition, which also mentions sources. The person skilled in the art is aware of processes for the production of these polyamides.

Polyamides to be used with very particular preference are nylon-6 (PA 6) or nylon-6,6 (PA 66), or blends mainly comprising polyamide.

Polyamides to be used with particular preference in the invention are semicrystalline polyamides which can be produced starting from diamines and dicarboxylic acids and/or from lactams having at least 5 ring members or from corresponding amino acids. Starting materials that can be used for this purpose are aliphatic and/or aromatic dicarboxylic acids, e.g. adipic acid, 2,2,4- and 2,4,4-trimethyladipic acid, azelaic acid, sebacic acid, isophthalic acid, terephthalic acid, aliphatic and/or aromatic diamines, e.g. tetramethylenediamine, hexamethylenediamine, 1,9-nonanediamine, 2,2,4- and 2,4,4-trimethylhexamethylenediamine, the isomeric diaminodicyclohexylmethanes, diaminodicyclohexylpropanes, bisaminomethylcyclohexane, phenylenediamines, xylylene-diamines, aminocarboxylic acids, e.g. aminocaproic acid, or the corresponding lactams. Copolyamides composed of a plurality of the monomers mentioned are included.

Polyamides particularly preferred according to the invention are those produced from caprolactams, very particularly preferably from ε-caprolactam, and most of the compounded materials based on PA 6, on PA 66, and on other aliphatic and/or aromatic polyamides or copolyamides, where these have from 3 to 11 methylene groups for each polyamide group in the polymer chain.

Semicrystalline polyamides to be used according to the invention can also be used in a mixture with other polyamides and/or with further polymers. It is also possible, therefore, to use polyamides which accord with DE 699 09 629 T2 in that the percentage by number of macromolecular chains of star type present is from 50% to 90%.

Conventional additives can be admixed in the melt of the polyamides, or applied to the surface, examples being mold-release agents, stabilizers and/or flow aids.

In one alternative embodiment, however, it is also possible to use PA recylates, if appropriate in a mixture with polyalkylene terephthalates, such as polybutylene terephtalates (PBT).

According to the invention, the term recyclates encompasses
1) “post-industrial recyclates”, which are production wastes arising during the polycondensation reaction or sprues arising during processing by injection molding, start-up products from injection molding or extrusion, or edge cuts of extruded sheets or foils, and
2) “post-consumer recyclates”, which are plastics items collected by the final consumer after use, and treated.

Both types of recyclate can be used either in the form of regrind or in the form of pellets. In the latter case, the crude recyclates are melted in an extruder, after separation and purification, and pelletized. This mostly facilitates handling and free flow, and metering for further steps of processing.

It is possible to use either pelletized recyclates or those in the form of regrind, but the maximum edge length here should be 10 mm, preferably below 8 mm

In the event that the intention is to add flow improvers, in addition to the polyamide, the molding compositions to be used in the invention can comprise at least one component B), where the component B) used can comprise flow improvers from the group of B1), and/or B2), and/or B3), and/or B4).

In the invention, B1) represents copolymers, preferably random copolymers composed of at least one olefin, preferably α-olefin, and of at least one methacrylic ester or acrylic ester of an aliphatic alcohol. In one preferred embodiment, these are random copolymers composed of at least one olefin, preferably α-olefin, and of at least one methacrylic ester or acrylic ester whose MFI is not less than 100 g/10 min, preferably not less than 150 g/10 min, particularly preferably not less than 300 g/10 min, where, for the purposes of the present invention, the MFI (melt flow index) was measured or determined uniformly at 190° C. using a test weight of 2.16 kg.

In one particularly preferred embodiment, the copolymer B1) is composed of less than 4% by weight, particularly preferably less than 1.5% by weight and very particularly preferably 0% by weight, of monomer units which contain further reactive functional groups selected from the group consisting of epoxides, oxetanes, anhydrides, imides, aziridines, furans, acids, amines and oxazolines.

Olefins, preferably α-olefins, suitable as constituent of the copolymers B1) preferably have from 2 to 10 carbon atoms and can be unsubstituted or can have substitution by one or more aliphatic, cycloaliphatic or aromatic groups.

Preferred olefins are those selected from the group consisting of ethene, propene, 1-butene, 1-pentene, 1-hexene, 1-octene, 3-methyl-1-pentene. Particularly preferred olefins are ethene and propene, and ethene is particularly preferred.

Mixtures of the olefins described are also suitable.

In an embodiment to which further preference is given, the further reactive functional groups of the copolymer B1), selected from the group consisting of epoxides, oxetanes, anhydrides, imides, aziridines, furans, acids, amines, oxazolines, are introduced exclusively by way of the olefins into the copolymer B1).

The content of the olefin in the copolymer B1) is from 50 to 90% by weight, preferably from 55 to 75% by weight.

The copolymer B1) is further defined via the second constituent alongside the olefin. A suitable second constituent is alkyl esters or arylalkyl esters of acrylic acid or methacrylic acid whose alkyl or arylalkyl group is formed from 1 to 30 carbon atoms. The alkyl or arylalkyl group here can be linear or branched, and also can contain cycloaliphatic or aromatic groups, and alongside this can also have substitution by one or more ether or thioether functions. Other suitable methacrylates or acrylates in this connection are those synthesized from an alcohol component based on oligoethylene glycol or on oligopropylene glycol having only one hydroxy group and at most 30 carbon atoms.

With preference, the alkyl group or arylalkyl group of the methacrylate or acrylate can have been selected from the group consisting of methyl, ethyl, n-propyl, isopropyl, n-butyl, isobutyl, tert-butyl, sec-butyl, 1-pentyl, 1-hexyl, 2-hexyl, 3-hexyl, 1-heptyl, 3-heptyl, 1-octyl, 1-(2-ethyl)hexyl, 1-nonyl, 1-decyl, 1-dodecyl, 1-lauryl or 1-octadecyl. Preference is given to alkyl groups or arylalkyl groups having from 6 to 20 carbon atoms. Preference is particularly also given to branched alkyl groups which have the same number of carbon atoms as linear alkyl groups but give a lower glass transition temperature T_{G}.

Further details relating to flow improvers B1 are described in EP-A-1 756 225.

The molding compositions according to the invention can comprise, as component B), as an alternative to B1) or in addition to B1), from 0.01 to 50% by weight, preferably from 0.5 to 20% by weight and in particular from 0.7 to 10% by weight, of B2) at least one highly branched or hyperbranched polycarbonate with an OH number of from 1 to 600 mg KOH/g of polycarbonate, preferably from 10 to 550 mg KOH/g of polycarbonate and in particular from 50 to 550 mg KOH/g of polycarbonate (to DIN 53240, Part 2) or of at least one hyperbranched polyester as component B3) or mixtures of B1) with B2) or of B2) with B3) or of B1) with B3) or a mixture of B1) with B2) and with B3).

For the purposes of this invention, hyperbranched polycarbonates B2) are non-crosslinked macromolecules having hydroxy groups and carbonate groups, these having both structural and molecular non-uniformity. Their structure may firstly be based on a central molecule in the same way as dendrimers, but with non-uniform chain length of the branches. Secondly, they may also have a linear structure with functional side groups, or else they may combine the two extremes, having linear and branched molecular portions. See also P. J. Flory, J. Am. Chem. Soc. 1952, 74, 2718, and H. Frey et al., Chem. Eur. J. 2000, 6, no. 14, 2499 for the definition of dendrimeric and hyperbranched polymers.

“Hyperbranched” in the context of the present invention means that the degree of branching (DB), i.e. the average number of dendritic linkages plus the average number of end groups per molecule, is from 10 to 99.9%, preferably from 20 to 99%, particularly preferably from 20 to 95%.

“Dendrimeric” in the context of the present invention means that the degree of branching is from 99.9 to 100%. See H. Frey et al., Acta Polym. 1997, 48, 30 for the definition of “degree of branching”.

Component B2) preferably has a number-average molar mass Mn of from 100 to 15 000 g/mol, preferably from 200 to 12 000 g/mol, and in particular from 500 to 10 000 g/mol (GPC, PMMA standard).

The glass transition temperature Tg is in particular from −80 to +140° C., preferably from −60 to 120° C. (according to DSC, DIN 53765).

In particular, the viscosity (mPas) at 23° C. (to DIN 53019) is from 50 to 200 000, in particular from 100 to 150 000, and very particularly preferably from 200 to 100 000.

Component B2) is preferably obtainable via a process described in DE 10 2004 049 342 A1.

In an alternative embodiment, the flow improver added to the molding compositions (B3) based on the polyamide to be extruded can comprise at least one hyperbranched polyester of AₓB_{y} type, where

x is at least 1.1, preferably at least 1.3, in particular at least 2 and
y is at least 2.1, preferably at least 2.5, in particular at least 3.

Use may also be made of mixtures as units A and/or B, of course.

An AₓB_{y}-type polyester is a condensate composed of an x-functional molecule A and a y-functional molecule B. By way of example, mention may be made of a polyester composed of adipic acid as molecule A (x=2) and glycerol as molecule B (y=3).

For the purposes of this invention, hyperbranched polyesters B3) are non-crosslinked macromolecules having hydroxy groups and carboxy groups, these having both structural and molecular non-uniformity. Their structure may firstly be based on a central molecule in the same way as dendrimers, but with non-uniform chain length of the branches. Secondly, they may also have a linear structure with functional side groups, or else they may combine the two extremes, having linear and branched molecular portions. See also P. J. Flory, J. Am. Chem. Soc. 1952, 74, 2718, and H. Frey et al., Chem. Eur. J. 2000, 6, no. 14, 2499 for the definition of dendrimeric and hyperbranched polymers.

“Hyperbranched” in the context of the present invention means that the degree of branching (DB), i.e. the average number of dendritic linkages plus the average number of end groups per molecule, is from 10 to 99.9%, preferably from 20 to 99%, particularly preferably from 20 to 95%. “Dendrimeric” in the context of the present invention means that the degree of branching is from 99.9 to 100%. See H. Frey et al., Acta Polym. 1997, 48, 30 for the definition of “degree of branching”.

Component B3) preferably has a molar mass of from 300 to 30 000 g/mol, in particular from 400 to 25 000 g/mol, and very particularly from 500 to 20 000 g/mol, determined by means of GPC, PMMA standard, dimethylacetamide eluent.

B3) preferably has an OH number of from 0 to 600 mg KOH/g of polyester, preferably from 1 to 500 mg KOH/g of polyester, in particular from 20 to 500 mg KOH/g of polyester to DIN 53240, and preferably a COOH number of from 0 to 600 mg KOH/g of polyester, preferably from 1 to 500 mg KOH/g of polyester, and in particular from 2 to 500 mg KOH/g of polyester.

The Tg (glass transition temperature) is preferably from −50° C. to 140° C., and in particular from −50 to 100° C. (by means of DSC, to DIN 53765).

Preference is particularly given to those components B3) in which at least one OH or COOH number is greater than 0, preferably greater than 0.1, and in particular greater than 0.5.

Component B3 is obtainable by the processes described in DE 10 2004 049 342 A1.

The highly functional hyperbranched polyesters B3) are carboxy-terminated, carboxy- and hydroxy-terminated or hydroxy-terminated, but preferably only hydroxy-terminated.

The hyperbranched polycarbonates B2)/polyesters B3) used are particles whose size is from 20 to 500 nm. These nanoparticles are in finely dispersed form in the polymer blend, the size of the particles in the compounded material being from 20 to 500 nm, preferably from 50 to 300 nm.

Compounded materials of this type are available commercially, e.g. as Ultradur® high speed. The polyalkylene glycol esters (PAGE) B4) with low molecular weight, of the general formula (I)

R—COO—(Z—O)ₙOC—R

in which
R is a branched or straight-chain alkyl group having from 1 to 20 carbon atoms,
Z is a branched or straight-chain C₂ to C₁₅ alkylene group, and
n is a whole number from 2 to 20,
can likewise be used as flow improvers, and are known from WO 98/11164 A1. Particular preference is given to triethylene glycol bis(2-ethylhexanoate) (TEG-EH), marketed as TEG-EH-Plasticizer, CAS No. 94-28-0, by Eastman Chemical B. V., The Hague, Netherlands.

If mixtures of B) components are used, the ratios of the components B1) to B2) or B2) to B3) or B1) to B3) or B1) to B4) or B) to B4) or B3) to B4) are preferably from 1:20 to 20:1, in particular from 1:15 to 15:1 and very particularly from 1:5 to 5:1. If a ternary mixture is used composed of, for example, B1), B2) and B3), the mixing ratio is preferably from 1:1:20 to 1:20:1 or up to 20:1:1. This applies likewise to ternary mixtures using B4).

It will be understood that the specification and examples are illustrative but not limitative of the present invention and that other embodiments within the spirit and scope of the invention will suggest themselves to those skilled in the art.

### BRIEF DESCRIPTION OF THE SEVERAL VIEWS OF THE DRAWING(S)

In the drawings, wherein like reference numerals delineate similar elements throughout the several views:

FIG. 1 is an exemplary design of a force-input structure;

FIG. 2 is a diagram of the structure of a force-input structure with an angled force-input metal sheet;

FIG. 3 is an exemplary oil pan utilizing the invention.

### DETAILED DESCRIPTION OF THE INVENTION

### Examples

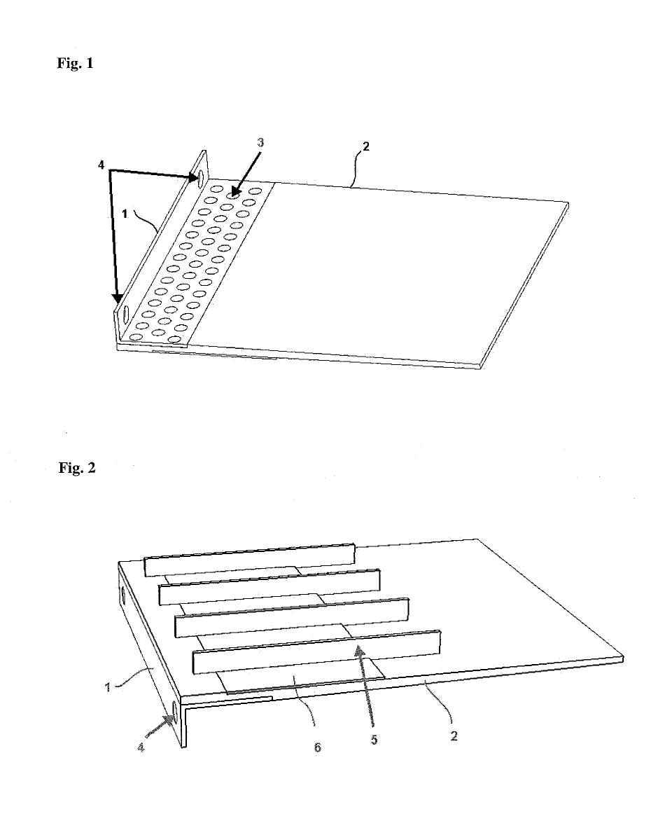

FIG. 1 shows the design of a force-input structure composed of angular sheetmetal and of an area of bonding to a plastics component by means of a perforation structure within the metal sheet.

FIG. 1 shows the structure of a force-input structure with the angled, thick-walled metal sheet 1 and with the molded-on thermoplastic 2. The forces are input from the local force-input points 4 into the plastics component by means of perforation structure 3 by way of the area of connection.

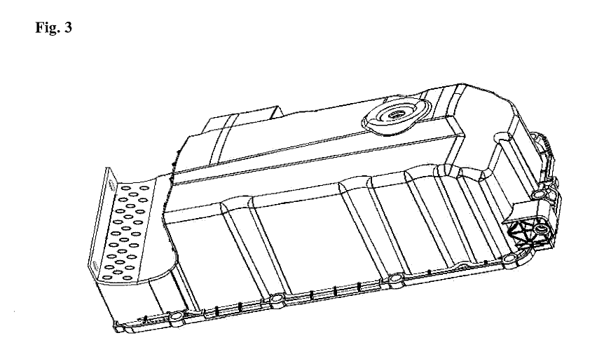

FIG. 2 is a diagram of the structure of a force-input structure with an angled force-input metal sheet 1 and with, to improve force dissipation, a second metal sheet 6 which has been molded onto that side of the plastics component opposite to the angled metal sheet. The ribs 5 standing perpendicularly on the surface of the plastics component are also shown, and inhibit buckling of the plastics component.

Depending on the prescribed geometry of specific components, it can be that the length of the main area of the metal sheet is not sufficient to produce uniform distribution of the force. It is therefore possible to use a second metal sheet on the opposite side, to improve force distribution.

In a first FEM study (FEM=finite element method) it was apparent that the system of FIG. 1 can transmit large forces up to 4000 N, which are input by way of the metal sheet at thickness 1 mm However, in this example of a calculation the plastics area with wall thickness 3 mm into which the force is input had to be stabilized by ribs to inhibit buckling. However, this is achievable without difficulty in the injection-molding process.

The FEM study was carried out using the ABAQUS program for the purposes of the present invention. The FEM study is described in detail at http://de.wikipedia.orgiwiki/Finite-Elemente-Methode.

FIG. 3 shows the example of an oil pan of the invention, provided with a force-input structure (in the left-hand portion of FIG. 1). The force-input structure here is a perforated sheetmetal with a formed metal strip, which has two fastening devices in the form of drilled holes.

What is claimed is:

1. A casing component, comprising
at least one force-input structure in the form of a metal sheet, for fastening a plastics casing component on an adjacent casing structure,
the plastic of the casing component being molded on to the metal sheet and bilaterally covers at least ⅔ of the force-input structure, and
the force-input structure comprises at least one fastening device for fastening the casing component to the casing structure by way of the force-input structure.

2. The casing component as claimed in claim 1, wherein the local forces to be introduced do not exceed the maximum permissible stress level of the metal sheet of the force-input structure.

3. The casing component as claimed in claim 1, wherein the plastics component is provided with ribs standing perpendicularly on the surface of the plastics component.

4. The casing component as claimed in claims 1, wherein the metal sheet is made of a steel alloy.

5. The casing component as claimed in claims 1, wherein the surface of the metal of the force-input structure is incipiently etched prior to the molding-on of the plastic.

6. The casing component as claimed in claims 1, wherein the molding-on process uses an interlock bond.

7. The casing component as claimed in claim 6, wherein the interlock bond includes a perforation structure of the metal sheet of the force-input structure.

8. The casing component as claimed in claim 1, wherein the metal sheet of the force-input structure has been angled.

9. The casing component as claimed in claim 1, wherein the plastic of the casing component comprises semicrystalline thermoplastics, provided in the form of molding compositions and extruded through shaping processes.

10. The casing component as claimed in claim 1, wherein the casing component is a metal-plastic-hybrid component.

11. A process for producing a casing component as claimed in claim 1, comprising the steps of
a) stamping and deepdrawing the force-input structure and the gasket flange and the attachment strip from a metal sheet material;
b) inserting the gasket flange with the attachment strip and with the force-input structure into a plastics-injection mold;
c) producing a wall region by injection molding, with
d) bilateral overmolding of the attachment strip.

12. A drive assembly including a casing component casing component, comprising
at least one force-input structure in the form of a metal sheet, for fastening a plastics casing component on an adjacent casing structure,
the plastic of the casing component being molded on to the metal sheet and bilaterally covers at least ⅔ of the force-input structure, and
the force-input structure comprises at least one fastening device for fastening the casing component to the casing structure by way of the force-input structure.

13. The casing component as claimed in claims 4, wherein the metal sheet is made of lightweight metals.

14. The casing component as claimed in claims 4, wherein the metal sheet comprises nonferrous metals.

15. The casing component as claimed in claim 10, wherein the casing component is an oil pan.

16. The casing component as claimed in claim 6, wherein the interlock bond includes a depressions in the metal sheet, or roughening of the surface of the metal sheet of the force-input structure.
